(19) United States
(12) Patent Application Publication
(10) Pub. No.: US 2009/0298976 A1
(43) Pub. Date: Dec. 3, 2009

(54) Fiber-Reinforced Composition Resin Composition, Adhesive and Sealant

(76) Inventors: Hiroyuki Yano, Uji (JP); Masaya Nogi, Kyoto (JP); Shinsuke Ifuku, Kyoto (JP); Kentaro Abe, Kyoto (JP); Yoshitaka Takezawa, Hitachi (JP); Keishin Handa, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/091,195

(22) PCT Filed: Oct. 26, 2006
(86) PCT No.: PCT/JP2006/321322

§ 371 Date: Jul. 31, 2009

(30) Foreign Application Priority Data
Oct. 26, 2005 (JP) 2005-311443

(51) Int. Cl. C09J 101/00

(52) U.S. Cl. 524/35

(57) ABSTRACT

An object of the present invention is to provide a fiber-reinforced composite resin composition for use as a sealant, adhesive, or filler, having a high transparency, and enabled to adequately meet recently required levels of low thermal expansion property, high strength, light weight, high thermal conductivity, and especially high, isotropic thermal conductivity. With the fiber-reinforced composite resin composition, the fibers have an average fiber diameter of 4 to 200 nm, a total light transmittance at wavelengths of 400 to 700 nm as measured with a 50 μm-thickness cured product, resulting from curing the composition to a plate-like form, is no less than 70%, both a thermal conductivity coefficient in a thickness direction and a thermal conductivity coefficient in a plate surface direction of the cured product are no less than 0.4 W/m·K, and the fibers are oriented randomly in the composition.

### BACKGROUND OF THE INVENTION

1. Field of the Invention

The present invention relates to a fiber-reinforced composite resin composition for use as a sealant, adhesive, or filler, and to be detailed, relates to a highly transparent fiber-reinforced composite resin composition for sealant, adhesive, or filler, containing fibers with a fiber diameter smaller than visible light wavelengths. The present invention also relates to an adhesive and a sealant using the fiber-reinforced composite resin composition.

2. Description of the Related Art

With a resin composition used as a sealant, adhesive, or filler, a cured product may be required to have a high transparency, low thermal expansion property, high strength, light weight, high thermal conductivity, and other characteristics according to application. For example, with a sealant material for an LED, a transparency that allows light emitted from a phosphor to be transmitted highly is required, and furthermore, a low thermal expansion coefficient, high strength, and light weight are required for securing dimensional stability and durability under usage environments and for making a product lightweight. Furthermore, with the realization of high performance, advanced functions, and compact size in the field of electronic equipment in recent years, heat that is generated in any of various equipments is continuing to increase and thus an excellent thermal conductivity is desired for efficient dissipation of the heat. These apply not only to sealants but also to adhesives and fillers used in such fields.

Although conventionally, an epoxy resin of high transparency is generally used as a sealant for an LED, etc., the recently required levels of low thermal expansion property, high strength, and high thermal conductivity cannot be attained with a resin alone.

Although for improvement of the thermal expansion coefficient, strength, and thermal conductivity coefficient of resin, blending of a reinforcing filler, etc., may be considered, the transparency is impaired significantly in this case, and depending on the filler material, a problem of increased weight also occurs. Also, although low price is of significant concern for industrial applications, depending on the filler used, the material cost may rise significantly.

Meanwhile, with the recent heightening of awareness for environmental conservation, development of products that are easy to scrap or reuse and are environment-friendly is desired for all industrial products.

The present applicant has priorly proposed, as a fiber-reinforced composite material that can constantly maintain a high transparency without being affected by temperature conditions, wavelength, etc., and has various functions added by composition of fibers and a matrix material, a fiber-reinforced composite material characterized in containing fibers, with an average fiber diameter of 4 to 200 nm, and a matrix material and having a light transmittance of no less than 60% at wavelengths of 400 to 700 nm as measured with a 50 μm-thickness product (Japanese Published Unexamined Patent Application No. 2005-60680).

However, with the fiber-reinforced composite material according to Japanese Published Unexamined Patent Application No. 2005-60680, use as a sealant, adhesive, or filler is not taken into consideration.

Also, although this fiber-reinforced composite material exhibits a high thermal conductivity coefficient in an in-plane direction (plate surface direction) of, for example, 1 W/m·K, the thermal conductivity in a direction orthogonal to the in-plane direction has not been made clear.

### SUMMARY OF THE INVENTION

An object of the present invention is to provide a fiber-reinforced composite resin composition for use as a sealant, adhesive, or filler, having a high transparency and enabled to adequately meet recently required levels of low thermal expansion property, high strength, light weight, high thermal conductivity, and especially high, isotropic thermal conductivity, and an adhesive and a sealant using the fiber-reinforced composite resin composition.

Another object of the present invention is to provide a lightweight and environment-friendly fiber-reinforced composite resin composition for a sealant, adhesive, or filler, and an adhesive and a sealant using the fiber-reinforced composite resin composition.

A fiber-reinforced composite resin composition according to (a first aspect of) the present invention is used as a sealant, adhesive, or filler, includes fibers and a liquid precursor of a matrix resin, and with this fiber-reinforced composite resin composition, the fibers have an average fiber diameter of 4 to 200 nm, a total light transmittance at wavelengths of 400 to 700 nm as measured with a 50 μm-thickness cured product, resulting from curing the composition to a plate-like form, is no less than 70%, both a thermal conductivity coefficient in a thickness direction and a thermal conductivity coefficient in a plate surface direction of the cured product are no less than 0.4 W/m·K, and the fibers are oriented randomly inside the composition.

With the present invention, the “liquid precursor of the matrix resin” refers to a liquid substance that forms the matrix resin upon curing. “Oriented randomly inside the composition” refers to a state where the fibers are dispersed in the composition without being drawn into alignment.

According to a second aspect of the present invention, the fibers in the fiber-reinforced composite resin composition of the first aspect are cellulose fibers.

According to a third aspect of the present invention, the cellulose fibers in the fiber-reinforced composite resin composition of the second aspect are bacterial cellulose.

According to a fourth aspect of the present invention, the cellulose fibers in the fiber-reinforced composite resin composition of the second aspect are separated from plant fibers.

According to a fifth aspect of the present invention, the cellulose fibers in the fiber-reinforced composite resin composition of the third or fourth aspect are formed by subjecting microfibrillated cellulose fibers furthermore to a grinding process.

According to a sixth aspect of the present invention, a content of the fibers in the fiber-reinforced composite resin composition of any of the first to fifth aspects is no less than 10 weight %.

According to a seventh aspect of the present invention, the matrix resin in the fiber-reinforced composite resin composition of any of the first to fifth aspects is one type or two or more types of resin selected from the group consisting of acrylic resins, methacrylic resins, epoxy resins, urethane resins, phenol resins, unsaturated polyester resins, vinyl ester resins, diaryl phthalate resins, silicone resins, and heat-curing polyimide resins.

An adhesive according to (an eighth aspect of) the present invention uses such a fiber-reinforced composite resin composition according to the present invention.

A sealant according to (a ninth aspect of) the present invention uses such a fiber-reinforced composite resin composition according to the present invention.

Because the fiber-reinforced composite resin composition according to the present invention uses fibers having an average fiber diameter smaller than the wavelengths (380 to 800 nm) of visible light, visible light is hardly refracted at interfaces of the matrix resin and the fibers in a cured product of the composition. The cured product of the fiber-reinforced composite resin composition according to the present invention thus has a high transparency across the entire visible light wavelength range.

Also, with the fiber-reinforced composite resin composition according to the present invention, because a cured product with a low and isotropic linear thermal expansion coefficient can be obtained by blending of randomly oriented fibers in the composition, distortion, deformation, and lowering of shape precision due to ambient temperature is unlikely to be a problem. Furthermore, by selection of the fiber material, the product can be made lightweight and inexpensive.

Moreover, by random orientation of the fibers in the composition, the cured product, resulting from curing the composition into plate-like form, can be made a highly thermal conductive material that has a high thermal conductivity coefficient of no less than 0.4 W/m·K not only in the plate surface direction (hereinafter referred to as “in-plane direction”) but also in the thickness direction (hereinafter referred to as “plane thickness direction”) and is thus isotropic, in other words, is not anisotropic in thermal conductivity, and a sealant, adhesive, or filler with a high heat dissipating property can thus be provided.

The fiber-reinforced composite resin composition according to the present invention having such a high transparency and a high, isotropic thermal conductivity is extremely high in industrial value. That is, for example, although inorganic glass, which is known as a material of high thermal conductivity coefficient, exhibits a high thermal conductivity coefficient of approximately 1 W/m·K in both the in-plane and plane thickness directions as indicated in Reference Example 1 described below (see Table 1), it has problems in terms of lightweightness and mechanical strength. Also, an epoxy resin, which is generally used as a highly transparent resin, exhibits a thermal conductivity coefficient of only approximately 0.2 W/m·K in both the in-plane and plane thickness direction as indicated in Comparative Example 1 described below (see Table 1). Although the thermal conductivity coefficient is improved when a ceramic filler, etc., of high conductivity is blended in the epoxy resin, the transparency is impaired completely in this case.

In contrast, with the present invention, a sealant, adhesive, or filler that is lightweight, highly transparent, and exhibits a high, isotropic thermal conductivity and a low expansion characteristic can be provided.

The fiber-reinforced composite resin composition according to the present invention is thus useful in applications of sealants, fillers, etc., especially in integrated LED illumination systems for automobiles and power elements, in which heat generation amount has been increasing recently due to high current levels and thus high heat dissipating properties are required.

The fiber-reinforced composite resin composition according to the present invention that contains biodegradable cellulose fibers as the fibers is lightweight and is moreover advantageous for scrapping or recycling in enabling treatment in accordance with a method for treating the matrix resin in a disposal process.

Embodiments of a fiber-reinforced composite resin composition, an adhesive, and a sealant according to the present invention shall now be described in detail.

The fiber-reinforced composite resin composition according to the present invention is used as a sealant, adhesive, or filler, contains fibers with an average fiber diameter of 4 to 200 nm and a liquid precursor of a matrix resin, and a cured product of the composition is highly transparent and exhibits a predetermined total light transmittance.

### BRIEF DESCRIPTION OF THE DRAWINGS

FIG. 1 is an internal transparent perspective view of a sample for measurement of thermal conductivity coefficients.

### DETAILED DESCRIPTION OF THE PREFERRED EMBODIMENTS

### Fibers with an Average Fiber Diameter of 4 to 200 nm

The fibers with the average fiber diameter of 4 to 200 nm used in the present invention may be constituted of fibers that are present in adequately defibrated form so that single fibers are not drawn into alignment and the liquid precursor of the matrix resin can enter between the fibers. Here, the average fiber diameter is an average diameter of the single fibers. The fibers according to the present invention may also constitute a single thread by collection of a plurality (may be a large number) of single fibers in a bundle, and in this case, the average fiber diameter is defined as an average value of the diameter of a single thread. Bacterial cellulose, to be described below, is constituted of the latter-mentioned threads.

With the present invention, because when the average fiber diameter of the fibers used exceeds 200 nm, the fiber diameter approaches visible light wavelengths and, in the cured product, refraction of visible light at interfaces with the matrix resin is made more difficult and the transparency thus degrades, the upper limit of the average fiber diameter of the fibers used in the present invention is set to 200 nm. Because fibers with an average fiber diameter of less than 4 nm are difficult to manufacture and, for example, a single fiber diameter of the below-described bacterial cellulose, which is favorable as the fibers, is approximately 4 nm, the lower limit of the average fiber diameter of the fibers used in the present invention is set to 4 nm. The average fiber diameter of the fibers used in the present invention is preferably 4 to 100 nm and more preferably 4 to 60 nm.

Although the fibers used in the present invention may include fibers of fiber diameter outside the range of 4 to 200 nm as long as the average fiber diameter is in the range of 4 to 200 nm, a proportion of such fibers is preferably no more than 30 weight %, and the fiber diameters of all of the fibers are desirably no more than 200 nm, more desirably no more than 100 nm, and most desirably no more than 60 nm.

Although the fibers are not restricted in particular in regard to length, an average length of no less than 100 nm is preferable. When the average length of the fibers is less than 100 nm, the reinforcement effect is low and there is a possibility for the cured product obtained to be inadequate in strength. Although fibers with a fiber length of less than 100 nm may be included, the proportion of such fibers is preferably no more than 30 weight %.

With the present invention, the use of cellulose fibers as the fibers is preferable because a fiber-reinforced composite resin composition that is lightweight and environment-friendly can then be provided.

Cellulose fibers refer to cellulose microfibrils that constitute a basic framework of plant cell walls or to constituent fibers thereof and are normally an aggregate of unit fibers with a fiber diameter of approximately 4 nm. As the cellulose fibers, those containing a crystalline structure at a proportion of no less than 40% are preferable in terms of achieving high strength and low thermal expansion.

The cellulose fibers used in the present invention may be separated from plants, or bacterial cellulose, produced by bacteria, may be used. As bacterial cellulose, that obtained by subjecting a bacterial product to an alkali treatment to eliminate the bacteria by lysis is preferably used without defibration.

Bacterial cellulose and cellulose fibers separated from plant fibers shall now be described, and with the present invention, one type of the below-mentioned fibers may be used alone or two or more types may be used in combination.

### <Bacterial Cellulose (May be Abbreviated Hereinafter as “Bc”)>

Organisms that produce cellulose on Earth not only include species of the Kingdom Plantae, but also include sea squirts in the Kingdom Animalia, various algae, oomycetes, myxomycetes, etc., in the Kingdom Protista, and a portion of cyanobacteria, acetic acid bacteria, and soil bacteria in the Kingdom Monera. Presently, cellulose production capability has not been found in the Kingdom Fungi (Eumycota). Among the acetic acid bacteria, although the genus Acetobacter, etc., can be cited and Acetobacter aceti, Acetobacter subsp., Acetobacter xylinum, etc., can be cited as specific examples, acetic acid bacteria that produce cellulose are not restricted to these.

When such bacteria are cultured, cellulose is produced from the bacteria. Because the product that is obtained contains both the bacteria and the cellulose fibers (bacterial cellulose), produced from the bacteria and linked to the bacteria, hydrated bacterial cellulose that does not contain bacteria can be obtained by taking out the product from a culture medium and then washing the product with water or performing alkali treatment to eliminate the bacteria.

As examples of the culture medium, agar-like solid media and liquid media (culture solutions) can be cited, and as examples of a culture solution, a culture solution which contains 7 weight % coconut milk (total nitrogen: 0.7 weight %, fat content: 28 weight %) and 8 weight % sucrose and is adjusted to pH 3.0 by acetic acid; an aqueous solution (SH medium) which contains 2 weight % glucose, 0.5 weight % bactoyeast extract, 0.5 weight % bactopeptone, 0.27 weight % disodium hydrogen phosphate, 0.115 weight % citric acid, and 0.1 weight % magnesium sulfate heptahydrate and is adjusted to pH 5.0 by hydrochloric acid, etc., can be cited.

As examples of culturing methods, static culturing, shaking culturing, stirring culturing, etc., can be cited. For example, as a static culturing method, a coconut culture solution is inoculated with Acetobacter xylinum FF-88 or other acetic acid bacteria, and in the case of FF-88, static culturing is carried out for 5 days at 30° C. to obtain a primary culture solution. After removing a gel portion of the primary culture solution thus obtained, a liquid portion is added at a proportion of 5 weight % to a culture solution of the same type mentioned above and static culturing is carried out for 10 days at 30° C. to obtain a secondary culture solution. The secondary culture solution contains cellulose fibers at a proportion of approximately 1 weight %.

As another culturing method, a method using the aqueous solution (SH culture solution), containing 2 weight % glucose, 0.5 weight % bactoyeast extract, 0.5 weight % bactopeptone, 0.27 weight % disodium hydrogen phosphate, 0.115 weight % citric acid, and 0.1 weight % magnesium sulfate heptahydrate and adjusted to pH 5.0 by hydrochloric acid, can be cited. In this case, the SH culture solution is added to a strain of acetic acid bacteria in a lyophilized state and static culturing is carried out for one week (25 to 30° C.). Bacterial cellulose is produced at a surface of the culture solution, and a portion of comparatively high thickness is selected and a small amount of the culture solution of the corresponding strain is batched off and added to a new culture solution. This culture solution is then placed in a large-scale incubator and static culturing is carried out for 7 to 30 days at 25 to 30° C. Bacterial cellulose is thus obtained by repeating a procedure of “adding a portion of an existing culture solution to a new culture solution and carrying out static culturing for approximately 7 to 30 days.”

If a problem, such as the bacteria not producing cellulose readily, occurs, the following procedure is performed. That is, a small amount of a culture solution, in which the bacteria are cultured, is inoculated in an agar medium, prepared by adding agar to the culture solution, and a colony is made to form by letting the culture medium stand for approximately one week. Each colony is then observed, and a colony that seems to be producing cellulose comparatively well is taken out from the agar medium, loaded into a new culture solution, and cultured.

Bacterial cellulose thus produced is taken out from the culture solution and the bacteria remaining in the bacterial cellulose are eliminated. As methods for this, water washing or alkali treatment, can be cited. As alkali treatment for lysing and eliminating the bacteria, a method where the bacterial cellulose, taken out from the culture solution, is added to an aqueous alkaline solution of approximately 0.01 to 10 weight % for no less than one hour can be cited. After the alkali treatment, the bacterial cellulose is taken out from the alkali treatment solution and washed adequately with water to eliminate the alkali treatment solution.

The hydrated bacterial cellulose (bacterial cellulose with a water content of normally 95 to 99 weight %) thus obtained is then subject to a pulverization/grinding treatment to break apart the fibers and thereby obtain cellulose fibers.

More specifically, cellulose fibers, obtained by cutting the hydrated bacterial cellulose to approximately 5 mm square and pulverizing with a mixer, etc., are prepared into an aqueous suspension of approximately 0.1 to 3 weight % and furthermore subjected repeatedly to grinding or fluxing by a grinder, etc., to obtain nano-order bacterial cellulose (hereinafter abbreviated as “NBC”) with an average fiber diameter of 4 to 200 nm. By then replacing the water content in the aqueous suspension by a resin raw material monomer, etc., that is a liquid precursor, a fiber-reinforced composite resin composition is obtained.

As a method for replacing the water content in the aqueous suspension by the resin raw material monomer, etc., a method, such as that of repeatedly injecting and discharging ethanol or other intermediary liquid that is compatible with water to remove the water content from the periphery of the cellulose fibers and then impregnating the fibers with the resin raw material monomer or other liquid precursor, can be cited.

Such a method of using an intermediary liquid to replace the water content by the liquid precursor shall be described in detail below in the “Impregnation method using an intermediary liquid” section.

A method, where, while mechanically stirring the aqueous suspension, the intermediary liquid, compatible with water, and the liquid precursor are injected in a stepwise manner and the water content and the intermediary liquid are volatilized and discharged with priority under reduced pressure to replace the water content by the liquid precursor, may also be employed. In this case, the intermediary liquid is used as suitable, and there may be cases where the intermediary liquid is not used.

As yet another method of replacing the water content in the aqueous suspension by the resin raw material monomer, etc., that is the liquid precursor, a method, where the aqueous suspension is lyophilized to obtain an aggregate of the cellulose fibers and the aggregate is impregnated with the liquid precursor, can be cited.

By these methods, a fiber-reinforced composite resin composition, in which the fibers are randomly oriented with aggregation among fibers being suppressed, can be obtained readily. These methods are examples, and the method for replacing the water content in the aqueous suspension by the liquid precursor in the manufacture of the fiber-reinforced composite resin composition according to the present invention are not restricted to these methods.

The above-mentioned grinding or fluxing treatment can be performed using, for example, the grinder, “Pure Fine Mill,” manufactured by Kurita Machinery Manufacturing Co., Ltd., etc.

This grinder is a millstone grinder, with which a raw material is ground into ultrafine particles by an impact, a centrifugal force, and a shear force generated when the raw material passes through a gap between two vertically disposed grinders and which enables shearing, grinding, microparticulation, dispersion, emulsification, and fibrillation to be achieved simultaneously. The grinding or fluxing treatment can also be performed using the ultramicroparticulate grinder, “Serendipiter,” manufactured by Masuko Sangyo Co., Ltd. The Serendipiter is a grinder that can achieve microparticulation beyond a range of simply grinding and enables production of particles that imparts feeling as if they are melting. The Serendipiter is a millstone type ultramicroparticulate grinder, constituted of two poreless grindstones disposed vertically in a manner enabling a gap in between to be adjusted freely, and the upper grindstone is fixed while the lower grindstone rotates at high speed. A raw material loaded into a hopper is fed into the gap between the upper and lower grindstones by centrifugal force and gradually ground and ultramicroparticulated by the extremely high compression, shear, and rolling friction generated between the grindstones.

<Cellulose Fibers Separated from Plant Fibers>

With the present invention, besides the above-described bacterial cellulose, cellulose fibers, obtained by subjecting seaweed, sea squirt tunic, plant cell wall, etc., to a beating/grinding treatment, high-temperature, high-pressure steam treatment, treatment using a phosphate salt, etc., may be used.

In this case, in the beating/grinding treatment, force is directly applied to a plant cell wall, seaweed, or sea squirt tunic, from which lignin, etc., have been removed, to break apart fibers and thereby obtain cellulose fibers.

More specifically and as shall be described below with an embodiment, by preparing an approximately 0.1 to 3 weight % aqueous suspension of microfibrillated cellulose fibers (hereinafter, abbreviated as “MFC”) by treating and microfibrillating pulp, etc., to an average fiber diameter of approximately 0.1 to 10 μm by a high-pressure homogenizer and then furthermore grinding or fluxing repeatedly by a grinder, etc., nano-order MFC (hereinafter, abbreviated as “nano-MFC”) with an average fiber diameter of 10 to 100 nm can be obtained. By then preparing the nano-MFC into an aqueous suspension of approximately 0.01 to 1 weight % and replacing the water content by the resin raw material monomer, etc., that is to be the liquid precursor, the fiber-reinforced composite resin composition is obtained. The details of the replacement method are the same as those described above in relation to the bacterial cellulose fibers.

The above-mentioned grinding or fluxing treatment can be performed using, for example, the grinder, “Pure Fine Mill,” manufactured by Kurita Machinery Manufacturing Co., Ltd., etc.

In the high-temperature, high-pressure steam treatment, a plant cell wall, seaweed, or sea squirt tunic, from which lignin, etc., have been removed, is exposed to high-temperature, high-pressure steam to break apart fibers and thereby obtain cellulose fibers.

In the treatment using a phosphate salt, etc., a surface of a plant cell wall, seaweed, or sea squirt tunic is phosphorylated to weaken a binding force among cellulose fibers and a refiner treatment is performed to break apart fibers and thereby obtain cellulose fibers. For example, the plant cell wall, seaweed, or sea squirt tunic, from which lignin, etc., have been removed, is immersed in a solution containing 50 weight % urea and 32 weight % phosphoric acid, the solution is made to seep adequately between the cellulose fibers at 60° C., and thereafter heating at 180° C. is performed to promote phosphorylation. Water washing is then performed, a hydrolysis treatment is performed in 3 weight % aqueous hydrochloric acid solution for 2 hours at 60° C., and then water washing is performed again. By thereafter treating in a 3 weight % aqueous sodium carbonate solution for approximately 20 minutes at room temperature, the phosphorylation is completed. By then fibrillating the treatment product by a refiner, cellulose fibers are obtained.

Two or more types of these cellulose fibers, obtained from different plants or subject to different treatments, may be mixed and used.

The hydrated nano-MFC that is thus obtained is normally in a state where water is impregnated in a fiber aggregate with a sub-network structure (a structure, which, although not having a complete (clear) network structure such as in bacterial cellulose, has locally-formed networks) of single fibers with an average fiber diameter of approximately 100 nm.

Besides pulp, cotton (for example, dry cotton or cotton linter), products of pulp refined by any of various methods, such as “Tencel” (registered trademark), manufactured by Lenzing Inc., “Ceolas” (registered trademark), manufactured by Asahi Kasei Chemicals Corp., and “Avicel” (registered trademark), manufactured by Asahi Kasei Chemicals Corp., products of refined cotton, such as cuprammonium regenerated cellulose (Cupra), etc., may be used.

### <Modification of Fibers>

The fibers used in the present invention may be those with which the above-mentioned cellulose fibers are heightened in functionality by both or either of chemical modification and physical modification. As examples of chemical modification, addition of a functional group by acetylation, cyanoethylation, acetalation, etherification, isocyanation, etc., composition or coating with a silicate, titanate, or other inorganic substance by a chemical reaction or sol-gel method, etc., can be cited. As an example of a chemical modification method, a method of immersing and heating a BC sheet or nano-MFC sheet in acetic anhydride can be cited, and by the acetylation, a water absorbing property can be lowered and heat resistance can be improved without lowering light transmittance. As examples of physical modification, surface coating by a metal or ceramic raw material by vacuum vapor deposition, ion plating, sputtering, or other physical vapor deposition method (PVD method), chemical vapor deposition method (CVD) method, electroless plating, electroplating, or other plating method, etc., can be cited.

### <Content of the Fibers in the Composition>

With the present invention, the content of the fibers in the fiber-reinforced composite resin composition is no less than 7 weight %, especially preferably no less than 10 weight %, and especially preferably no more than 75 weight %. When the content of the fibers in the fiber-reinforced composite resin composition is too low, the effects of improved thermal conductivity coefficient, improved flexural strength, improved flexural modulus, and reduced linear thermal expansion coefficient of the cured product due to the cellulose fibers or other fibers tend to be inadequate, and when the content is too high, adhesion between fibers or filling of spaces between fibers by the matrix resin becomes inadequate and the strength, transparency, and flatness of surface upon curing is possibly degraded, and in particular, adhesive properties, filling properties, etc., which are due to the matrix resin and are important in a sealant, adhesive, or filler application, become impaired.

### [Matrix Resin]

The fiber-reinforced composite resin composition according to the present invention contains the matrix resin liquid precursor that forms the matrix resin upon curing. The matrix resin liquid precursor shall be described later and the matrix resin formed by curing of the matrix resin liquid precursor shall now be described.

The matrix resin is a material that becomes a base material of the cured product formed by curing of the fiber-reinforced composite resin composition according to the present invention, and is not restricted in particular as long as the light transmitting characteristics required by the present invention are satisfied and characteristics required of a sealant, adhesive, or filler application are met, and one type of any of various resin materials may be used alone or two or more types of resin materials may be mixed and used.

Although matrix resins favorable for the present invention shall now be described as examples, the matrix resin used in the present invention is by no means restricted to these.

As examples of natural resin materials, regenerated cellulose-based polymers, such as cellophane, triacetyl cellulose, etc., can be cited.

As examples of synthetic resin materials, vinyl based resins, polycondensation-based resins, polyaddition-based resins, addition condensation-based resins, ring opening polymerization-based resins, etc., can be cited.

As examples of the vinyl-based resins, polyolefins, vinyl chloride-based resins, vinyl acetate-based resins, fluororesins, (meth)acrylic-based resins, and other general-purpose resins, and engineering plastics and super-engineering plastics, obtained by vinyl polymerization, etc., can be cited. These may be homopolymers or copolymers of respective constituent monomers in the respective resins.

As examples of the polyolefins, homopolymers and copolymers of ethylene, propylene, styrene, butadiene, butene, isoprene, chloroprene, isobutylene, isoprene, etc., and cyclic polyolefins having a norbornene skeleton, etc., can be cited.

As examples of the vinyl chloride-based resins, homopolymers and copolymers of vinyl chloride, vinylidene chloride, etc., can be cited.

As examples of the vinyl acetate-based resins, polyacetate vinyls, which are homopolymers of vinyl acetate, polyvinyl alcohols, which are hydrolysis products of polyacetate vinyls, polyvinyl acetals, produced by reacting formaldehyde or n-butyraldehyde with vinyl acetate, polyvinyl butyrals, produced by reacting polyvinyl alcohols with butyraldehyde, etc., can be cited.

As examples of the fluororesins, homopolymers and copolymers of tetrachloroethylene, hexafluoropropylene, chlorotrifluoroethylene, vinylidene fluoride, perfluoroalkyl vinyl ethers, etc., can be cited.

As examples of the (meth) acrylic-based resins, homopolymers and copolymers of (meth)acrylic acid, (meth)acrylonitrile, (meth) acrylic acid esters, (meth) acrylamides, etc., can be cited. In the present specification, “(meth) acrylic” refers to “both or either of acrylic and methacrylic.” Here, as the (meth)acrylic acid, acrylic acid and methacrylic acid can be cited. As the (meth) acrylonitrile, acrylonitrile and methacrylonitrile can be cited. As examples of the (meth)acrylic acid esters, alkyl (meth)acrylates, (meth)acrylic acid-based monomers having a cycloalkyl group, alkoxyalkyl(meth)acrylates, etc., can be cited. As examples of the alkyl(meth)acrylates, methyl (meth)acrylate, ethyl(meth)acrylate, butyl(meth)acrylate, 2-ethylhexyl(meth)acrylate, cyclohexyl(meth)acrylate, benzyl (meth)acrylate, lauryl(meth)acrylate, stearyl(meth)acrylate, hydroxyethyl(meth)acrylate, etc., can be cited. As examples of the (meth) acrylic acid-based monomers having a cycloalkyl group, cyclohexyl(meth)acrylate, isobornyl(meth)acrylate, etc., can be cited. As examples of the alkoxyalkyl(meth)acrylates, 2-methoxyethyl(meth)acrylate, 2-ethoxyethyl(meth)acrylate, 2-butoxyethyl(meth)acrylate, etc., can be cited. As examples of the (meth)acrylamides, (meth)acrylamide, N-methyl (meth)acrylamide, N-ethyl(meth)acrylamide, N,N-dimethyl (meth)acrylamide, N,N-diethyl(meth)acrylamide, N-isopropyl (meth)acrylamide, N-t-octyl(meth)acrylamide, and other N-substituted (meth)acrylamides, etc., can be cited.

As examples of the polycondensation-based resins, amide-based resins, polycarbonates, etc., can be cited.

As examples of the amide-based resins, 6,6-nylon, 6-nylon, 11-nylon, 12-nylon, 4,6-nylon, 6,10-nylon, 6,12-nylon and other aliphatic amide-based resins, and aromatic polyamides, constituted of phenylenediamine or other aromatic diamine and terephthaloyl chloride, isophthaloyl chloride, or other aromatic dicarboxylic acid or derivative thereof, can be cited.

“Polycarbonate” refers to a reaction product of bisphenol-A or a bisphenol that is a derivative thereof and phosgene or phenyl dicarbonate.

As examples of the polyaddition-based resins, ester-based resins, U polymers, liquid crystal polymers, polyether ketones, polyether ether ketones, unsaturated polyesters, alkyd resins, polyimide-based resins, polysulfones, polyphenylene sulfides, polyether sulfones, etc., can be cited.

As examples of the ester-based resins, aromatic polyesters, aliphatic polyesters, unsaturated polyesters, etc., can be cited. As examples of the aromatic polyesters, copolymers of a diol to be described below, such as ethylene glycol, propylene glycol, 1,4-butanediol, etc., and an aromatic dicarboxylic acid, such as terephthalic acid, etc., can be cited. As examples of the aliphatic polyesters, copolymers of a diol to be described below and an aliphatic dicarboxylic acid, such as succinic acid, valeric acid, etc., homopolymers and copolymers of glycolic acid, lactic acid, and other hydroxycarboxylic acids, copolymers of an diol to be described later, an above-mentioned aliphatic dicarboxylic acid, and an above-mentioned hydroxycarboxylic acid, etc., can be cited. As examples of the unsaturated polyesters, copolymers of a diol to be described below, an unsaturated dicarboxylic acid, such as maleic anhydride, etc., and, where necessary, a vinyl monomer, such as styrene, etc., can be cited.

As examples of the U polymers, copolymers constituted of bisphenol-A or a bisphenol that is a derivative thereof and terephthalic acid, isophthalic acid, etc., can be cited.

“Liquid crystal polymers” refers to copolymers of p-hydroxybenzoic acid and terephthalic acid, p,p′-dioxydiphenol, p-hydroxy-6-naphthoic acid, ethylene polyterephthalate, etc.

As examples of the polyether ketones, homopolymers and copolymers of 4,4-difluorobenzophenone, 4,4-dihydrobenzophenone, etc., can be cited.

As examples of the polyether ether ketones, copolymers of 4,4-difluorobenzophenone and hydroquinone, etc., can be cited.

As examples of the alkyd resins, copolymers constituted of a higher fatty acid, such as stearic acid, palmitic acid, etc., a dibasic acid, such as phthalic anhydride, and a polyol, such as glycerin, can be cited.

As examples of the polysulfones, copolymers of 4,4-dichlorodiphenylsulfone and bisphenol A, etc., can be cited.

As examples of the polyphenylene sulfides, copolymers of p-dichlorobenzene and sodium sulfide, etc., can be cited.

As examples of the polyether sulfones, polymers of 4-chloro-4′-hydroxydiphenylsulfone can be cited.

As examples of the polyimide-based resins, pyromellitic acid type polyimides, which are copolymers of polymellitic anhydride and 4,4′-diaminodiphenyl ether, etc., trimellitic acid type polyimides, which are copolymers constituted of trimellitic anhydride, an aromatic diamine, such as p-phenylenediamine, a diisocyanate compound to be described below, etc., biphenyl type polyimides, constituted of biphenyltetracarboxylic acid, 4,4-diaminodiphenyl ether, p-phenylenediamine, etc., benzophenone type polyimides, constituted of benzophenonetetracarboxylic acid, 4,4-diaminodiphenyl ether, etc., and bismaleimide type polyimides, constituted of bismaleimide, 4,4-diaminodiphenylmethane, etc., can be cited.

As examples of the polyaddition-based resins, urethane resins, etc., can be cited.

An urethane resin is a copolymer of a diisocyanate and a diol. As examples of the diisocyanates, dicyclohexylmethane diisocyanate, 1,6-hexamethylene diisocyanate, isophorone diisocyanate, 1,3-cyclohexylene diisocyanate, 1,4-cyclohexylene diisocyanate, 2,4-trilene diisocyanate, 2,6-trilene diisocyanate, 4,4′-diphenylmethane diisocyanate, 2,4′-diphenylmethane diisocyanate, 2,2′-diphenylmethane diisocyanate, etc., can be cited. As examples of the diols, ethylene glycol, propylene glycol, 1,3-propanediol, 1,3-butanediol, 1,4-butanediol, 1,5-pentanediol, 3-methyl-1,5-pentanediol, 1,6-hexanediol, neopentyl glycol, diethylene glycol, trimethylene glycol, triethylene glycol, tetraethylene glycol, dipropylene glycol, tripropylene glycol, cyclohexanedimethanol, and other comparatively low molecular weight diols, and polyester diols, polyether diols, polycarbonate diols, etc., can be cited.

As examples of the addition condensation-based resins, phenol resins, urea resins, melamine resins, etc., can be cited.

As examples of the phenol resins, homopolymers and copolymers of phenol, cresol, resorcinol, phenylphenol, bisphenol-A, bisphenol-F, etc., can be cited.

The urea resins and melamine resins are copolymers of formaldehyde and urea, melamine, etc.

As examples of the ring-opening polymerization resins, polyalkylene oxides, polyacetals, epoxy resins, etc., can be cited. As examples of the polyalkylene oxides, homopolymers and copolymers of ethylene oxide, propylene oxide, etc., can be cited. As examples of the polyacetals copolymers of trioxane, formaldehyde, ethylene oxide, etc., can be cited. As examples of the epoxy resins, aliphatic-based epoxy resins, constituted of ethylene glycol or other polyvalent alcohol and epichlorohydrin, aliphatic-based epoxy resins, constituted of bisphenol-A and epichlorohydrin, etc., can be cited.

With the present invention, among such matrix resins, an amorphous synthetic resin material with a high glass transition temperature (Tg) is especially preferable from the viewpoint of obtaining a fiber-reinforced composite resin composition of high durability and excellent transparency, and here, in regard to the degree of amorphousness, a crystallinity of no more than 10% and especially no more than 5% is preferable, and the Tg is preferably no less than 110° C., more preferably no less than 120° C., and most preferably no less than 130° C. With a resin with a Tg of less than 110° C., problems of durability, such as deformation upon contact with boiling water, may occur. The Tg is determined by measurement by a DSC method, and the crystallinity is determined by a density method of calculating the crystallinity from densities of an amorphous portion and a crystalline portion.

With the present invention, examples of especially preferable transparent matrix resins include acrylic resins, methacrylic resins, epoxy resins, urethane resins, phenol resins, unsaturated polyester resins, vinyl ester resins, diaryl phthalate resins, silicone resins, heat curing type polyimide resins and other heat curing type resins, and among these, acrylic resins, methacrylic resins, epoxy resins, and silicone resins of especially high transparency are preferable.

In a case where cellulose fibers are used as the fibers, by using a biodegradable polylactic acid resin as the matrix resin, the fiber-reinforced composite resin composition as a whole can be made biodegradable and easy to be discarded.

### [Method for Manufacturing the Fiber-Reinforced Composite Resin Composition]

A method for manufacturing the fiber-reinforced composite resin composition according to the present invention shall now be described.

To manufacture the fiber-reinforced composite resin composition according to the present invention, the matrix resin liquid precursor that can form the matrix resin, such as that described above, is impregnated into the fibers.

Here, as the liquid precursor, one type or two or more types of substance, selected from among the group consisting of fluid-form matrix resins, fluid-form matrix resin raw materials, fluidized products resulting from fluidization of matrix resins, fluidized products resulting from fluidization of matrix resin raw materials, solutions of matrix resins, and solutions of matrix resin raw materials, can be used.

The fluid-form matrix resins refer to matrix resins, which are fluid in themselves, etc. As examples of the fluid-form matrix resin raw materials, prepolymers, oligomers, and other polymerization intermediates, etc., can be cited.

Furthermore, as examples of the fluidized products resulting from fluidization of matrix resins, thermoplastic matrix resins in a heated, molten state, etc., can be cited.

As examples of the fluidized products resulting from fluidization of matrix resin raw materials, prepolymers, oligomers, and other polymerization intermediates of solid form that are put in a heated, molten state, etc., can be cited.

As examples of the solutions of matrix resins, and the solutions of matrix resin raw materials, solutions, with which a matrix resin or a matrix resin raw material is dissolved in a solvent, etc., can be cited. The solvent is determined as appropriate according to the matrix resin or matrix resin raw material to be dissolved, and in cases where the solvent is eliminated by vaporization in a subsequent elimination step, a solvent having a boiling point of no more than a temperature such that degradation of the matrix resin or the matrix resin raw material does not occur is preferable.

Such a matrix resin liquid precursor is impregnated into an aggregate of the fibers and the liquid precursor is made to permeate adequately between the fibers. Preferably, a portion or an entirety of the impregnation process is performed in a pressure varying state. Depressurization and pressurization can be cited as methods for varying the pressure. When depressurization or pressurization is performed, replacement of air that is present between the fibers by the liquid precursor is facilitated and remaining of air bubbles can be prevented. Or, by loading the aggregate of the fibers into a liquid of the liquid precursor and replacing the air by the liquid precursor by performing mechanical stirring, the fibers can readily be oriented randomly in an interior of the liquid precursor while suppressing aggregation of the fibers.

As a depressurization condition, 0.133 kPa (1 mmHg) to 93.3 kPa (700 mmHg) is preferable. When the depressurization condition is higher than 93.3 kPa (700 mHg), the elimination of air becomes inadequate and air may remain between the fibers. Meanwhile, although the depressurization condition may be lower than 0.133 kPa (1 mmHg), a depressurization equipment tends to become excessively large in this case.

A treatment temperature for the impregnation process under the depressurization condition is preferably no less than 0° C. and more preferably no less than 10° C. If the temperature is less than 0° C., the elimination of air becomes inadequate and air may remain between the fibers. An upper limit of the temperature, for example, in a case where a solvent is used in the liquid precursor, is preferably a boiling point (boiling point under the depressurization condition) of the solvent. If the temperature becomes higher than this, volatilization of the solvent becomes severe and air bubbles become more likely to remain.

As a pressurization condition, 1.1 to 10 MPa is preferable. When the pressurization condition is lower than 1.1 MPa, the elimination of air becomes inadequate and air may remain between the fibers. Meanwhile, although the pressurization condition may be higher than 10 MPa, a pressurization equipment tends to become excessively large in this case.

A treatment temperature for the impregnation process under the pressurization condition is preferably 0 to 300° C. and more preferably 10 to 100° C. If the temperature is less than 0° C., the elimination of air becomes inadequate and air may remain between the fibers. Meanwhile, if the temperature is higher than 300° C., modification of the matrix resin may occur.

### <Impregnation Method Using an Intermediary Liquid>

Because the aggregate of the cellulose fibers that constitute the fiber-reinforced composite resin composition according to the present invention is a three-dimensionally crossing structure, it is poor in permeability of the matrix resin liquid precursor and in some cases, it may not be possible to carry out the impregnation process efficiently.

Thus with the present invention, an impregnation process using an intermediary liquid may be carried out.

That is, first, in the cellulose fiber aggregate manufacturing process, the hydrated NBC, hydrated nano-MFC, or other hydrated fiber aggregate, in the state before the water removal treatment and containing water, is eliminated of only a portion of the water content and is put in a state of containing a slight amount of water, and the water in the hydrated fiber aggregate is replaced by an intermediary liquid, having compatibility with both or either of the water and the matrix resin liquid precursor to obtain a fiber-reinforced composite resin precursor (first step), and then the intermediary liquid in the fiber-reinforced composite resin composition precursor is replaced by the matrix resin liquid precursor to obtain the fiber-reinforced composite resin composition (second step).

With the present invention, having “compatibility” means that when two liquids are mixed at arbitrary proportions and left to stand, the mixture does not separate into two layers.

With respect to the intermediary liquid, in order to smoothly perform the replacement of the water contained in the hydrated fiber aggregate with the intermediary liquid in the first step, and the replacement of the intermediary liquid contained in the fiber aggregate with the matrix resin liquid precursor in the second step to be described below, in addition to exhibiting mutual compatibility, the intermediary liquid preferably has a lower boiling point than those of water and the liquid precursor, and in particular, a water-soluble organic solvent, such as methanol, ethanol, propanol, isopropanol, or other alcohol; acetone or other ketone; tetrahydrofuran, 1,4-dioxane, or other ether; N,N-dimethylacetamide, N,N-dimethylformamide, or other amide; acetic acid or other carboxylic acid; acetonitrile or other nitrile; pyridine or other aromaticheterocyclic compound, etc., is preferable, and from the viewpoint of ease of acquisition, handling properties, etc., ethanol or acetone, etc., is preferable. One type of such a water-soluble organic solvent may be used alone or two or more types may be used upon mixing.

Although the intermediary liquid differs according to whether it has compatibility with both water and the liquid precursor, or has compatibility with either, or, in a case where the intermediary liquid has compatibility with the liquid precursor, according to the type of liquid precursor and is selected and used accordingly, depending on the case, water, a mixture of an above-mentioned water-soluble solvent and water, an aqueous solution having an inorganic compound dissolved therein, etc., may be used as the intermediary liquid.

A method for replacing the water in the hydrated fiber aggregate by the intermediary liquid is not restricted in particular and, for example, a method, where the hydrated fiber aggregate is immersed in the intermediary liquid and left to stand for a predetermined time to make the water in the hydrated fiber aggregate leach out to the intermediary liquid side and the intermediary liquid containing the water that has leached out is exchanged appropriately to replace the water in the fiber aggregate by the intermediate solution, can be cited. A temperature condition of this immersion replacement is preferably set in a range of approximately 0 to 60° C. to prevent volatilization of the intermediary liquid, and the procedure is normally performed at room temperature.

Although the proportion of replacement of water by the intermediary liquid is most preferably 100%, it is preferable for at least 10% or more of the water in the hydrated fiber aggregate to be replaced by the intermediary liquid.

By thus replacing the water in the hydrated fiber aggregate by the matrix resin liquid precursor, the fiber-reinforced composite resin composition, with which the matrix resin liquid precursor is impregnated in the fiber aggregate, is obtained. A fiber content of the fiber-reinforced composite resin composition is approximately 7 weight % to 75 weight %.

In the first step, the replacement of the water in the hydrated fiber aggregate by the intermediary liquid may be performed in a plurality of stages, i.e., two stages or more. That is, it is possible to prepare two types of mutually compatible intermediary liquids including a first intermediary liquid (for example, ethanol) and a second intermediary liquid (for example, acetone), with which, in regard to compatibilities with water and the matrix resin liquid precursor, the compatibilities with water are such that:

first intermediary liquid>second intermediary liquid; and the compatibilities with the matrix resin liquid precursor are such that:

first intermediary liquid<second intermediary liquid; and to firstly replace the water in the hydrated fiber aggregate by the first intermediary liquid to obtain the fiber aggregate with the first intermediary liquid impregnated in the fiber aggregate, and then replace the first intermediary liquid in the fiber aggregate, impregnated with the first intermediary liquid, by the second intermediary liquid to obtain the fiber aggregate, having the second intermediary liquid impregnated in the fiber aggregate, as the fiber-reinforced composite resin composition. The replacement may furthermore be performed in three or more stages using three or more types of intermediary liquid.

Although a method for replacing the intermediary liquid in the fiber aggregate by the matrix resin liquid precursor is not restricted in particular, a method where the fiber aggregate, impregnated with the intermediary liquid, is immersed in the matrix resin liquid precursor and maintained under a depressurization condition is preferable. The intermediary liquid in the fiber aggregate is thereby volatilized and by the matrix resin liquid precursor entering into the fiber aggregate in place of the intermediary liquid, the intermediary liquid in the fiber aggregate is replaced by the matrix resin liquid precursor.

Although the depressurization condition is not restricted in particular, 0.133 kPa (1 mmHg) to 93.3 kPa (700 mmHg) is preferable. When the depressurization condition is higher than 93.3 kPa (700 mmHg), the elimination of the intermediary liquid becomes inadequate and the intermediary liquid may remain between the fibers of the fiber aggregate. Meanwhile, although the depressurization condition may be less than 0.133 kPa (1 mmHg), the depressurization equipment tends to become excessively large in this case.

A treatment temperature for the replacement process under the depressurization-condition is preferably no less than 0° C. and more preferably no less than 10° C. If the temperature is less than 0° C., the elimination of the intermediary liquid becomes inadequate and the intermediary liquid may remain between the fibers. An upper limit of the temperature, for example, in a case where a solvent is used in the matrix resin liquid precursor, is preferably a boiling point (boiling point under the depressurization condition) of the solvent. If the temperature becomes higher than this, volatilization of the solvent becomes severe and air bubbles become more likely to remain.

The intermediary liquid in the fiber aggregate can also be replaced smoothly by the matrix resin liquid precursor by repeating depressurization and pressurization alternately in the state of immersing the fiber aggregate, impregnated with the intermediary liquid, in the matrix resin liquid precursor.

The depressurization condition is the same as that described above, and as a pressurization condition, 1.1 to 10 MPa is preferable. When the pressurization condition is less than 1.1 MPa, the elimination of the intermediary liquid becomes inadequate and the intermediary liquid may remain between the fibers. Meanwhile, although the pressurization condition may be higher than 10 MPa, the pressurization equipment tends to become excessively large in this case.

A treatment temperature for the impregnation process under the pressurization condition is preferably 0 to 300° C. and more preferably 10 to 100° C. If the temperature is less than 0° C., the elimination of the intermediary liquid becomes inadequate and the intermediary liquid may remain between the fibers. Meanwhile, if the temperature is higher than 300° C., modification of the matrix resin may occur.

Although the proportion of replacement of the intermediary liquid in the fiber aggregate by the matrix resin liquid precursor is most preferably 100%, it is preferable for at least 0.2% or more of the intermediary liquid in the fiber aggregate to be replaced by the matrix resin liquid precursor.

The fiber-reinforced composite resin composition according to the present invention may contain, in addition to the above-described fibers and matrix resin liquid precursor, an antioxidant or other additive within a range that does not impair the objects of the present invention.

### [Method for Curing the Fiber-Reinforced Composite Resin Composition]

Curing of the fiber-reinforced composite resin composition according to the present invention is performed according to a method for curing the matrix resin liquid precursor that is used and, as an example in a case where the liquid precursor is a fluid-form matrix resin, use of a crosslinking reaction, a chain elongation reaction, etc., can be cited. In a case where the liquid precursor is a fluid-form raw material of the matrix resin, use of a polymerization reaction, a crosslinking reaction, a chain elongation reaction, etc., can be cited.

In a case where the liquid precursor is a fluidized product resulting from fluidization of the matrix resin, cooling, etc., can be cited. In a case where the liquid precursor is a fluidized product resulting from fluidization of a matrix resin raw material, combination of cooling, etc., and use of a polymerization reaction, a crosslinking reaction, a chain elongation reaction, etc., can be cited.

In a case where the liquid precursor is a solution of the matrix resin, elimination of the solvent in the solution by evaporation, air drying, etc., can be cited. Furthermore, in a case where the liquid precursor is a solution of a raw material of the matrix resin, combination of elimination of the solvent in the solution, etc., and use of a polymerization reaction, a crosslinking reaction, a chain elongation reaction, etc., can be cited. The evaporation elimination refers not only to evaporation elimination under normal pressure but also inclusively to evaporation elimination under reduced pressure.

### [Light Transmittance of the Cured Product]

With the fiber-reinforced composite resin composition according to the present invention, a plate-like cured product, obtained by using the composition and performing curing by the method for curing the matrix resin liquid precursor, is a highly transparent material with which a total light transmittance at wavelengths of 400 to 700 nm as measured with a 50 μm-thickness product is no less than 70%.

When the total light transmittance is lower than the above-mentioned lower limit value, a sealant, adhesive, or filler of high transparency that is aimed at by the present invention cannot be provided.

With the present invention, the total light transmittance at wavelengths of 400 to 700 nm as measured with a 50 μm-thickness product (may be referred to hereinafter as the “50 μm thickness total visible light transmittance”) of the plate-like cured product is a value that is measured as follows.

### <Method for Measuring the 50 μm Thickness Total Visible Light Transmittance>

The fiber-reinforced composite resin composition according to the present invention is cured in accordance with the method for curing the matrix resin liquid precursor to obtain a plate-like cured product, and the 50 μm thickness total visible light transmittance is determined by conversion to 50 μm thickness of an average value of the total light transmittance in an entire wavelength range when light of wavelengths of 400 to 700 nm is illuminated onto the cured product in a thickness direction.

The light transmittance can be determined by using air as a reference and measuring a total transmitted light upon positioning a light source and a detector across a substrate to be measured (sample substrate) so as to be perpendicular to the substrate.

### [Thermal Conductivity Coefficients of the Cured Product]

With the fiber-reinforced composite resin composition according to the present invention, a thermal conductivity coefficient in a thickness direction (plane thickness direction) and a thermal conductivity coefficient in a plate surface direction (in-plane direction) of the plate-like cured product, obtained by using the composition and performing curing by the method for curing the matrix resin liquid precursor, are both preferably no less than 0.4 W/m·K.

With the fiber-reinforced composite resin composition according to the present invention, high thermal conductivity coefficients are exhibited isotropically in both the plane thickness direction and the in-plane direction because the fibers are oriented randomly without being aggregated inside the composition.

Due to having the high, isotropic thermal conductivity, with the thermal conductivity coefficients being high in both the plane thickness direction and the in-plane direction, a sealant, adhesive, or filler of excellent heat dissipating property can be provided.

With the present invention, the thermal conductivity coefficients in the plane thickness direction and the in-plane direction of the plate-like cured product are values that are measured as follows.

### <Method for Measuring the Thermal Conductivity Coefficients>

The fiber-reinforced composite resin composition according to the present invention is cured in accordance with the method for curing the matrix resin liquid precursor to thereby obtain the plate-like cured product, and the thermal conductivity coefficient in the in-plane direction of the cured product is measured by AC calorimetry and the thermal conductivity coefficient in the plane thickness direction is measured by temperature wave analysis. More specifically, the measurements methods are as described by way of examples below.

### [Application of the Fiber-Reinforced Composite Resin Composition]

The fiber-reinforced composite resin composition according to the present invention is used as a sealant, adhesive, or filler.

### EXAMPLES

Although the present invention shall now be described in further detail by citing examples, a comparative example, and a reference example, the present invention is not restricted as long as these examples do not depart from the spirit of the invention. Methods for measuring various physical properties of the fiber-reinforced composite resin composition and the cured product thereof are as follows.

### [50 μm Thickness Total Visible Light Transmittance]

### <Measurement Apparatus>

The “UV-4100 Spectrometer” (solid-state sample measurement system), manufactured by Hitachi High-Technologies Corp., is used.

### <Measurement Conditions>

A 6 mm×6 mm light source mask is used.

A measurement is made with a measurement sample being set at a position 22 cm away from an opening of an integrating sphere. By setting the sample at this position, diffusely transmitted light is eliminated and only rectilinearly transmitted light reaches a light receiving unit in an interior of the integrating sphere.

A reference sample is not used. Because there is no reference, loss of transmittance due to Fresnel reflection occurs (when Fresnel reflection, which is reflection resulting from a refractive index difference between the sample and air, occurs, a rectilinear transmittance of 100% is not possible).

Scan speed: 300 nm/min

Light source: Tungsten lamp and deuterium lamp

Light source switching wavelength: 340 nm

### [Thermal Conductivity Coefficients (Plane Thickness Direction and In-Plane Direction)]

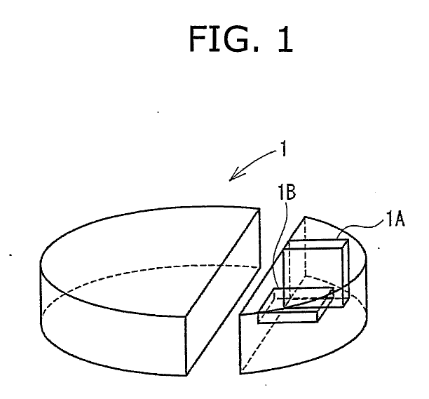

First, a sample 1 with a diameter of 50 mm and a thickness of 10 mm is prepared, and samples 1A and 1B are processed by cutting to a size of 7 mm×7 mm×0.5 mm thickness each in the in-plane direction and plane thickness direction as shown in FIG. 1, and these are measured by the temperature wave analysis (TWA) method by “ai-phase mobie,” manufactured by ai-phase Co., Ltd.

### [Linear Expansion Coefficient]

A linear expansion coefficient is measured under the following measurement conditions using “TMA/SS6100,” manufactured by Seiko Instruments Inc. and in accordance with a method defined in ASTM D 6969.

### <Measurement Conditions>

Temperature raising condition: 5° C./min

Atmosphere: in N₂

Heating temperature: 50 to 150° C.

Load: 3 g

Number of measurements: 3 times

Sample length: 4×15 mm

Sample thickness: differs according to sample

Mode: tension mode

### [Crystallinity]

Crystallinity is defined as a proportion of area of crystalline scattering peaks in an X-ray diffraction diagram obtained by an X-ray diffraction measurement. A sample is set on a sample holder, and measurements are made upon controlling a diffraction angle of X-ray diffraction from 10° to 32°. After removal of background scattering from the X-ray diffraction diagram, an area formed by joining 10°, 18.5°, and 32° along an X-ray diffraction curve is an amorphous portion and the rest is a crystalline portion. Cellulose crystallinity is computed according to the following equation as a proportion of the crystalline portion with respect to an area of the entire diffraction diagram.

Crystallinity=(Area of crystalline portion)/(Area of entire X-ray diffraction diagram)×100(%)

### Example 1

### Fiber-Reinforced Composite Resin Composition Containing BC

First, a culture solution was added to a strain (FF-88) of acetic acid bacteria in a lyophilized preservation state and static culturing was carried out for one week (25 to 30° C.). Of the bacteria cellulose formed on the culture solution surface, that of comparatively high thickness was selected and a small amount of the culture solution of the corresponding strain was batched off and added to a new culture solution. This culture solution was then placed in a large-scale incubator and static culturing was carried out for 7 to 30 days at 25 to 30° C. As the culture solution, an aqueous solution (SH medium), containing 2 weight % glucose, 0.5 weight % bactoyeast extract, 0.5 weight % bactopeptone, 0.27 weight % disodium hydrogen phosphate, 0.115 weight % citric acid, and 0.1 weight % magnesium sulfate heptahydrate and adjusted to pH 5.0 by hydrochloric acid, was used.

The hydrated bacterial cellulose thus produced was taken out from the culture solution, and to eliminate the bacteria in the bacterial cellulose by lysis, the bacterial cellulose was boiled for 2 hours in a 2 weight % aqueous alkaline solution and thereafter taken out from the alkali treatment solution and rinsed adequately to eliminate the alkali treatment solution. The hydrated bacterial cellulose thus obtained (bacterial cellulose with a water content of 95 to 99 weight %) was then cut to approximately 5 mm, thereafter prepared into a 1 weight % aqueous suspension of cellulose fibers ground by a mixer, etc., and then using a grinder (“Pure Fine Mill KMG1-10,” manufactured by Kurita Machinery Manufacturing Co., Ltd.), an operation of passing the aqueous suspension outward from a central portion between disks rotated at 1200 rpm in a substantially contacting state was performed approximately 30 times (30 passes).

The NBC (average fiber diameter: 50 nm) obtained by the grinder treatment was then prepared into a 0.2 weight % aqueous suspension, and by replacing the water by a liquid epoxy resin (prepared by blending 100 weight parts of a bisphenol-A type epoxy resin, YD8125, manufactured by Tohto Kasei Co., Ltd. and 64 weight parts of an amine-based curing agent, Jeffamine D-400, manufactured by Huntsman) by repeating a depressurization and pressurization process five times while stirring the liquid epoxy resin with a three-one motor, a fiber-reinforced composite resin composition was obtained.

The fiber-reinforced composite resin composition was cured at 60° C./3 h+120° C./3 h to prepare a sample of 50 mm diameter and 10 mm thickness (see symbol 1 in FIG. 1), plate-like samples for measurement were cut out (see symbols 1A and 1B in FIG. 1), and the 50 μm thickness total visible light transmittance, thermal conductivity coefficients, linear expansion coefficient, and cellulose crystallinity of the cured product were measured, with the results shown in Table 1.

### Example 2

### Fiber-Reinforced Composite Resin Composition Containing Nano-MFC Derived from Pulp

Microfibrillated cellulose: Besides stirring MFC (obtained by microfibrillating softwood kraft pulp (NBKP) by a high-pressure homogenizer treatment; average fiber diameter: 1 μm) in water adequately to prepare 7 kg of an aqueous suspension of 1 weight % concentration, epoxy resin was impregnated in the same manner as in Example 1 to manufacture a fiber-reinforced composite resin composition according to the present invention having nano-MFC oriented randomly inside the composition, and this fiber-reinforced composite resin composition and a cured product thereof were evaluated in the same manner as in Example 1, with the results shown in Table 1.

### Example 3

### Fiber-Reinforced Composite Resin Composition Containing Nano-MFC Derived from Cotton

Besides using cotton (dry cotton) in place of pulp, the same procedure as Example 1 was performed to impregnate with epoxy resin and thereby manufacture a fiber-reinforced composite resin composition according to the present invention having nano-MFC oriented randomly inside the composition, and this fiber-reinforced composite resin composition and a cured product thereof were evaluated in the same manner as in Example 1, with the results shown in Table 1.

### Example 4

### Fiber-Reinforced Composite Resin Composition Containing Nano-MFC Derived from Avicel

Besides using Avicel in place of pulp, the same procedure as Example 1 was performed to impregnate with epoxy resin and manufacture a fiber-reinforced composite resin composition according to the present invention having nano-MFC oriented randomly inside the composition, and this fiber-reinforced composite resin composition and a cured product thereof were evaluated in the same manner as in Example 1, with the results shown in Table 1.

### Example 5

### Fiber-Reinforced Composite Resin Composition Containing Nano-MFC Derived from Tencel (Registered Trademark)

Besides using Tencel (registered trademark) in place of pulp, the same procedure as Example 1 was performed to impregnate with epoxy resin and manufacture a fiber-reinforced composite resin composition according to the present invention having nano-MFC oriented randomly inside the composition, and this fiber-reinforced composite resin composition and a cured product thereof were evaluated in the same manner as in Example 1, with the results shown in Table 1.

### Example 6

### Fiber-Reinforced Composite Resin Composition Containing Nano-MFC Derived from Cupra

Besides using Cupra in place of pulp, the same procedure as Example 1 was performed to impregnate with epoxy resin and manufacture a fiber-reinforced composite resin composition according to the present invention having nano-MFC oriented randomly inside the composition, and this fiber-reinforced composite resin composition and a cured product thereof were evaluated in the same manner as in Example 1, with the results shown in Table 1.

### Example 7

### Fiber-Reinforced Composite Silicone Resin Based Composition Containing BC

BC was used in the same manner as in Example 1 and impregnated with a gel-form silicone resin (TSE3051, manufactured by GE Toshiba Silicone), curing was performed by heating at 100° C./4 h to manufacture a fiber-reinforced composite resin composition according to the present invention having NBC dispersed randomly inside the composition, and this fiber-reinforced composite resin composition and a cured product thereof were evaluated in the same manner as in Example 1, with the results shown in Table 1.

### Comparative Example 1

A cured product of an epoxy resin was evaluated in the same manner as in Example 1, with the results shown in Table 1.

### Reference Example 1

Inorganic glass was evaluated in the same manner as in Example 1, with the results shown in Table 1.

TABLE 1

| | | Examples | | | | | | | Comparative | Reference |
|---|---|---|---|---|---|---|---|---|---|---|
| Examples | | 1 | 2 | 3 | 4 | 5 | 6 | 7 | Example | Example |
| Fiber crystallinity (%) | | 69.2 | 50.9 | 62.6 | 61.6 | 72.8 | 56 | 69.2 | | |
| Fiber content of | | 50 | 70 | 70 | 75 | 46 | 42 | 10 | | |
| fiber-reinforced | | | | | | | | | | |
| composite resin | | | | | | | | | | |
| composition (%) | | | | | | | | | | |
| Cured | 50 μm thickness | 85.8 | 86 | 85 | 84.7 | 89 | 83.8 | 80 | | |
| product | total visible light | | | | | | | | | |
| | transmittance (%) | | | | | | | | | |
| | Thermal | 0.63 | 0.60 | 1.20 | 0.55 | 0.48 | 0.42 | 0.40 | 0.22 | 1 |
| | conductivity | | | | | | | | | |
| | coefficient | | | | | | | | | |
| | (in-plane direction) | | | | | | | | | |
| | (W/m · K) | | | | | | | | | |
| | Thermal | 0.50 | 0.53 | 0.85 | 0.51 | 0.40 | 0.40 | 0.40 | 0.22 | 1 |
| | conductivity | | | | | | | | | |
| | coefficient | | | | | | | | | |
| | (plane thickness | | | | | | | | | |
| | direction) | | | | | | | | | |
| | (W/m · K) | | | | | | | | | |
| | Linear expansion | 10 | 20 | 31 | 13 | 32 | 33 | 70 | | |
| | coefficient | | | | | | | | | |
| | (×10⁻⁶K⁻¹) | | | | | | | | | |

| | | | | | | | | | |
|---|---|---|---|---|---|---|---|---|---|
| Remarks | NBC/ | Pulp- | Cotton- | Avicel- | Tencel- | Cupra- | NBC/ | Epoxy resin | Inorganic |
| | Epoxy | derived | derived | derived | derived | derived | Silicone | | glass |
| | resin | nano-MFC/ | nano-MFC/ | nano-MFC/ | nano-MFC/ | nano-MFC/ | resin | | |
| | | Epoxy resin | Epoxy resin | Epoxy resin | Epoxy resin | Epoxy resin | | | |

From Table 1, it can be understood that the fiber-reinforced composite resin composition according to the present invention is a composition for sealant, adhesive, or filler that is highly transparent, high in thermal conductivity coefficients, and excellent in heat dissipating property. Especially with the Examples 1 to 3, in which fibers are oriented randomly, a sealant, adhesive, or filler that exhibits high thermal conductivity coefficients in both the in-plane direction and the plane thickness direction and thus has a high, isotropic thermal conductivity can be provided.

1. A fiber-reinforced composite resin composition, used as a sealant, adhesive, or filler, comprising fibers and a liquid precursor of a matrix resin, wherein the fibers have an average fiber diameter of 4 to 200 nm, a total light transmittance at wavelengths of 400 to 700 nm as measured with a 50 μm-thickness cured product, resulting from curing the composition to a plate-like form, is no less than 70%, both a thermal conductivity coefficient in a thickness direction and a thermal conductivity coefficient in a plate surface direction of the cured product are no less than 0.4 W/m·K, and the fibers are oriented randomly inside the composition.

2. The fiber-reinforced composite resin composition according to claim 1, wherein the fibers are cellulose fibers.

3. The fiber-reinforced composite resin composition according to claim 2, wherein the cellulose fibers are bacterial cellulose.

4. The fiber-reinforced composite resin composition according to claim 2, wherein the fibers are separated from plant fibers.

5. The fiber-reinforced composite resin composition according to claim 3, wherein the cellulose fibers are obtained by subjecting microfibrillated cellulose fibers furthermore to a grinding process.

6. The fiber-reinforced composite resin composition according to claim 1, wherein a content of the fibers is no less than 10 weight %.

7. The fiber-reinforced composite resin composition according to claim 1, wherein the matrix resin is one type or two or more types of resin selected from the group consisting of acrylic resins, methacrylic resins, epoxy resins, urethane resins, phenol resins, unsaturated polyester resins, vinyl ester resins, diaryl phthalate resins, silicone resins, and heat-curing polyimide resins.

8. An adhesive using the fiber-reinforced composite resin composition according to claim 1.

9. A sealant using the fiber-reinforced composite resin composition according to claim 1.

10. The fiber-reinforced composite resin composition according to claim 4, wherein the cellulose fibers are obtained by subjecting microfibrillated cellulose fibers furthermore to a grinding process.
